(19) United States
(12) Patent Application Publication
(10) Pub. No.: US 2026/0336980 A1
(43) Pub. Date: Oct. 29, 2026

(54) ELEVATOR CAR WITH A PIVOTABLE WORKING PLATFORM

(71) Applicant: Otis Elevator Company, Farmington, CT (US)

(72) Inventors: Arnaud Blanchard, Adon (FR); Yingjin Zhang, Shanghai (CN)

(21) Appl. No.: 19/410,542

(22) Filed: Dec. 5, 2025

(30) Foreign Application Priority Data
Apr. 28, 2025 (EP) 25305602.2

(51) Int. Cl. B66B 11/02; B66B 5/00; E06C 1/393

(52) U.S. Cl. CPC B66B 11/0246; B66B 5/0087; E06C 1/393

(57) ABSTRACT

An elevator car (6) with a working platform (21) pivotably mounted on a sidewall (22) of the elevator car (6), such that the working platform (21) is arranged adjacent and essentially parallel to the sidewall (22) of the elevator car (6) in a folded state. The working platform (21) protrudes from the sidewall (22) in an unfolded state, preferably in a 90° angle and comprises a standing plate (25).

### FOREIGN PRIORITY

This application claims priority to European Patent Application No. 25305602.2, filed Apr. 28, 2025, and all the benefits accruing therefrom under 35 U.S.C. § 119, the contents of which in its entirety are herein incorporated by reference.

### BACKGROUND

It is known from the art that users or mechanics climb on the roofs of an elevator car for maintenance or repairs on the upper area of the elevator car or a hoistway of the car. However, if a working platform and a balustrade is provided on top of the elevator car, a higher hoistway is needed for the elevator system. Thus, solutions exist with a working platform that is lowered from a ceiling of elevator car into the interior of the elevator car allowing the user to stand on it during the maintenance. However, these solutions have disadvantages. The integrated working platform in the ceiling makes the ceiling thicker, thus reducing the available height inside the elevator car. This can feel uncomfortable for users inside the elevator car. Furthermore, the lowering mechanisms that allow the extraction of the working platform from the ceiling are complex, rather expensive and susceptible to failures.

### SUMMARY

In view of the above-described problems, it is an object of the present disclosure to avoid or at least to mitigate the disadvantages of the related art, in particular to provide an elevator car that provides easy maintenance and preferably a simple and robust in-car working platform.

The present disclosure relates to an elevator car with a working platform pivotably/rotatably mounted on a sidewall of the elevator car. The working platform is arranged adjacent and in general parallel to the sidewall of the elevator car in a folded state and protrudes from the sidewall in an unfolded state, preferably in a 90° angle. The working platform comprises a standing plate and a ladder and the ladder is moveably connected to the standing plate.

It is to be understood that a sidewall of the elevator car can be any wall of the elevator car that is vertical. Therefore, the working platform can be positioned on every vertical sidewall of the elevator car. The sidewall from which the working platform may extend may also be a rear wall of the elevator car.

It is to be understood that the working platform abuts the sidewall in the folded state. Thus, the standing plate of the working platform may also be positioned right next to and essentially parallel to the sidewall.

In the unfolded state, the working platform and its standing platform may be arranged horizontal or essentially parallel to the floor.

Said differently, the elevator car/cage comprises a floor and four sidewalls extending vertically from the floor. One of the sidewalls or multiple sidewalls may comprise a door and the opposite sidewall may be referred to as the rear wall. Opposite from the floor, the elevator car also comprises a ceiling. The ceiling may be foldable/pivotable inside the elevator car. Thus, the ceiling may be openable. The working platform may be connected to the sidewall via hinges or joints that allow the working platform to pivot from the folded state into the unfolded state and backwards. The working platform comprises a standing plate configured for a user to stand on it during maintenance and a ladder configured for a user to climb the plate.

The present disclosure provides the following advantages. In the folded state, the working platform does not reach into the inner of the elevator car and thus, does not limit the space inside the elevator car. Furthermore, the working platform may be designed as a sidewall and thus is not seen in the folded state. The folding mechanism is very simple and robust, as only the working platform is moved. The working platform may be very inexpensive due to the simple folding mechanism. Because the ladder is movably connected to the standing plate, the ladder may be rigid and no telescopic ladder is needed.

Preferably, the ladder may be arranged adjacent and parallel to the standing plate in a folded/retracted state and may extend towards a floor of the elevator car in an extended state. The ladder may abut the standing plate and thus, does not require much space in the retracted state.

According to an optional aspect of the present disclosure, the ladder may abut against a lower surface of the standing plate in the retracted state and supports the standing plate in the extended state. The ladder may pivot from the retracted state being arranged under the standing plate into the extended state through gravity. The ladder may be positioned essentially vertically in the extended state, preferably in a right or 90° angle regarding the standing plate. However, the ladder may be positioned in a different angle regarding the standing plate.

It may be advantageous if the ladder extends in an angle regarding the sidewall from the standing plate. Thus, the ladder may have an angle different from a 90° angle regarding the standing plate. This may prevent the user from falling off the ladder.

In the extended state, the ladder may support or hold the working platform in the unfolded state. That minimizes the load on the hinges or joints between the sidewall and the standing plate.

Preferably, the ladder may abut against the upper surface of the standing plate and pivots around an edge of the standing plate, preferably around a longitudinal side and/or a side edge of the standing plate. The ladder may be slidably connected to the upper surface of the standing plate. Thus, the ladder may be moved essentially parallel to the standing plate in a first movement. When the ladder protrudes over an edge of the standing plate, the ladder may be pivoted/rotated in the direction of the floor. Thus, the space required between the edge of the standing plate and the sidewall may be minimized.

The ladder may be pivoted around the longitudinal side and/or a side edge of the standing plate.

A length of the ladder may be as long as a length of the standing plate. When the ladder is extended into its extended state, the ladder may be moved around the side edge of the standing plate. However, the ladder may be as long as a width of the standing plate. In this case, the ladder may be movable around the longitudinal side of the standing plate.

Alternatively, the ladder may be connected to the upper surface of the standing plate by a swivel joint/a revolute joint and may pivot around the edge of the standing plate into its extended state.

Advantageously, the working platform may comprise at least one supporting strut that is mounted on the standing plate on the one side and mounted on the sidewall of the elevator car on the opposite side. The at least one supporting strut holds/supports the working platform in its unfolded state. The at least one supporting strut provides an inexpensive and simple measure to hold the working platform in its unfolded state.

Preferably, the at least one supporting strut may comprise a first strut and a second strut that are pivotably connected to each. The first/wall side strut may be pivotably connected to the sidewall of the elevator car. The second strut may be pivotably connected to the working platform. The first strut and the second strut are pivotably/rotatably connected by a joint or hinge. In the folded state, the first strut and the second strut may be arranged essentially adjacent and parallel to each other. The first strut and the second strut may be in contact with each other in the folded state. Thus, the support strut is folded or tucked in the space between the sidewall and the working platform. The adjacent struts only require minimal space.

The first strut and the second strut may essentially form a straight line in the unfolded state. In other words the first strut and the second strut may be arranged in a essentially straight line, such that an angle between the first strut and the second strut may be essentially 180°.

The second/platform side strut may comprise a stopper/a mechanical stop that engages with a corresponding lock at the first strut and locks the two struts in the straight line/extended position. The mechanical stop and the corresponding lock may hold the two struts in their extended state. However, the mechanical stop may be arranged at the first strut and the lock may be arranged at the second strut. Thus, the first strut and the second strut may be locked together in the essentially straight line. The two struts may support the horizontal working platform in its unfolded state against the force of gravity.

The mechanical stop and/or the hinge between the first strut and the second strut may form an angle between the first strut and the second strut which allows the two struts to be folded against each other.

According to an optional and advantageous aspect of the present disclosure, the at least one supporting strut may be a pneumatic spring which is attached to a lower side of the standing plate. The standing plate may preferably be supported by two pneumatic springs, each on one side of the standing plate. Preferably, the pneumatic spring may be supported by the ladder in the extended state. The use of the pneumatic spring may provide a cheap supporting mechanism of the working platform.

Preferably, the working platform may be locked in the folded state with a locking mechanism, preferably a magnet. The magnet may be attached to the lower surface of the standing plate. The locking mechanism may secure the working platform in its folded state.

According to a further optional aspect of the present disclosure, the elevator car may comprise a chuck/vacuum lifting pad to pivot the working platform from the folded state in the unfolded state. Thus, it may be easy for the user/mechanic to fold the working platform out of the sidewall in its unfolded state. The user may grab/lift the working platform using the vacuum lifting pad for better and easier handling of the working platform.

Preferably, the standing plate may comprise a first layer and a second layer. The first layer may be made out of a panel material and the second layer may comprise wood, honeycomb or a composite material. Thus, the standing plate may be especially lightweight. That minimizes the effort that is required by a user to pivot the working platform into the unfolded state and also minimizes the requirements for the joints or hinges between the standing plate and the sidewall.

The panel material may provide a look like a sidewall of the elevator car. Thus, the working platform in its folded state, may be hidden in the sidewall or look like the sidewall. The working platform may alternatively be hidden behind a panel.

According to a further optional aspect of the present disclosure, the working platform may be mounted in a recessed area of the sidewall. The working platform may be pivoted around a hinge and also may execute a sliding movement after the pivoting movement. Thus, the working platform may slide in the recessed area of the sidewall until it closes with the rest of the sidewall to provide one planar sidewall surface.

In summary, the working platform is easy to manufacture and most of its components can be bought from suppliers and must not be designed from scratch. This working platform is also easy to operate. The working platform may be compatible with different dimensions of the elevator car. The standing plate may use the same surface material as the other sidewall panels.

The standing plate may comprise a steel frame on its outside and a wooden inner material. This makes the standing plate both robust and light.

### BRIEF DESCRIPTION OF THE DRAWINGS

In the following, exemplary embodiments of the disclosure are described in more detail with respect to the enclosed figures:

FIG. 1 depicts a schematic view of an elevator system according to an exemplary embodiment of the disclosure.

FIG. 2A depicts a view of an elevator car according to an embodiment of the present disclosure.

FIG. 2B depicts a view of an elevator car according to an embodiment of the present disclosure with an opened ceiling.

FIG. 2C depicts a view of an elevator car according to an embodiment of the present disclosure with a working platform in a folded state.

FIG. 2D depicts a view of an elevator car according to an embodiment of the present disclosure with the working platform in the folded state and a ladder in an extended state.

FIG. 3A depicts a schematical view of a supporting strut of the elevator car according to an embodiment of the present disclosure.

FIG. 3B depicts a schematical view of the supporting strut of the elevator car according to the embodiment of the present disclosure.

FIG. 4 depicts a working platform of the elevator car according to another embodiment of the present disclosure.

### DETAILED DESCRIPTION

The figures are schematical in nature only and solely intended to simplify the understanding of the disclosure.

Similar features of the embodiment shown in any of the figures shall be numbered accordingly.

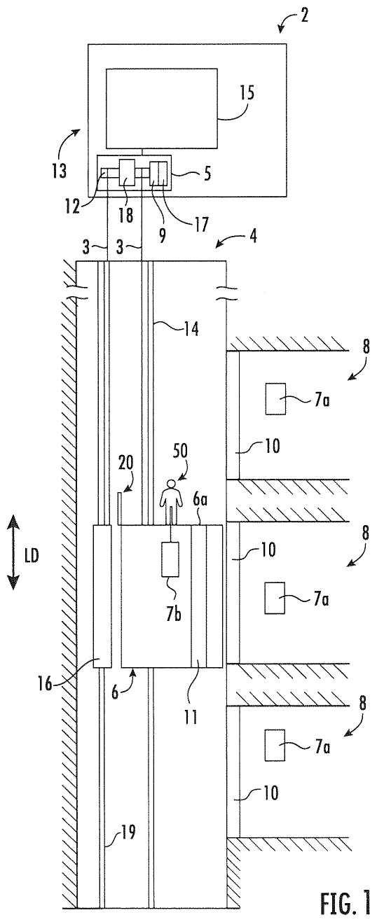

FIG. 1 schematically depicts an elevator system 2 according to an exemplary embodiment of the invention.

The elevator system 2 comprises a hoistway 4 extending along a longitudinal direction LD between a plurality of landings 8 located on different floors. The elevator system 2 includes an elevator car 6 that is arranged in the hoistway 4 for being moved along the longitudinal direction LD between the plurality of landings 8. The elevator car 6 may in particular be movable along at least one elevator car guide rail 14 provided in the hoistway 4 and extending along the longitudinal direction LD.

The longitudinal direction LD may be oriented in a vertical direction, as it is depicted in FIG. 1. In an alternative embodiment, which is not depicted in the figures, the longitudinal direction LD may be inclined with respect to the vertical direction.

Although only a single elevator car guide rail 14 is depicted in FIG. 1, the elevator system 2 may comprise a plurality of elevator car guide rails 14 extending parallel to each other.

Although only a single elevator car 6 is depicted in FIG. 1, exemplary embodiments of the invention may also include elevator systems 2 comprising a plurality of elevator cars 6 moving in one or more hoistways 4.

The elevator car 6 is movably suspended by means of a tension member 3. Although only a single tension member 3 is depicted in FIG. 1, exemplary embodiments of the invention may also include elevator systems 2 comprising a plurality of tension members 3.

The at least one tension member 3, for example a rope or belt, is coupled to an elevator drive system 5. The elevator drive system 5 comprises a motor 9 for rotatably driving a shaft 12, and a drive 17 that harnesses and controls the electrical energy supplied to the motor 9. The elevator drive system 5 is configured for driving the at least one tension member 3, which is coupled to the shaft 12 via traction, in order to move the elevator car 6 in the hoistway 4 along the longitudinal direction LD between the plurality of landings 8.

The elevator drive system 5 is further provided with at least one elevator brake 18 for braking rotation of the shaft 12 in order to allow for stopping movement of the elevator car 6 and holding the elevator car 6 at a desired position in the hoistway 4.

Optionally, the elevator system 2 may comprise a counterweight 16. The counterweight 16 may be attached to the at least one tension member 3 opposite to the elevator car 6 and configured for moving concurrently and in opposite direction with respect to the elevator car 6. The counterweight 16 may move along at least one counterweight guide rail 19 provided in the hoistway 4 and extending along the longitudinal direction LD.

The at least one tension member 3 may be a rope, e.g. a steel cord, or a belt, in particular a coated steel belt. The at least one tension member 3 may be uncoated. Alternatively, the at least one tension member 3 may be coated with a coating, e.g. with a coating having the form of a polymer jacket. In a particular embodiment, the at least one tension member 3 may be a belt comprising a plurality of polymer coated steel cords (not shown). The elevator system 2 may have a traction drive including a traction sheave for driving the at least one tension member 3.

In the exemplary embodiment depicted in FIG. 1, a 1:1 roping is employed for suspending the elevator car 6. The type of the roping is, however, not essential for the invention and different kinds of roping, e.g. a 2:1 roping or a 4:1 roping may be employed as well.

A landing door 10 is provided at each of the landings 8. The elevator car 6 is provided with a corresponding elevator car door 11 for allowing passengers to transfer between a landing 8 and the interior of the elevator car 6, when the elevator car 6 is positioned at the respective landing 8.

For moving the elevator car 6 along the hoistway 4 between the different landings 8, the elevator drive system 5 may be controlled by an elevator controller 15 of the elevator system 2.

The elevator system 2 may be a machine room-less elevator system 2. In an alternative embodiment, the elevator system 2 may comprise a machine room 13 housing the elevator drive system 5 and the elevator controller 15.

Input to the elevator controller 15 may be provided via landing control panels 7a provided on every landing 8, in particular in the vicinity of the landing doors 10, and/or via an elevator car control panel 7b provided inside the elevator car 6.

The landing control panels 7a may comprise elevator hall call buttons and/or destination call buttons. Destination call buttons allow passengers to enter their respective destinations before entering the elevator car 6. In case the landing control panels 7a are equipped with destination call buttons, no elevator car control panel 7b needs to be provided inside the elevator car 6 since the elevator system 2 is fully controlled by the commands input via the landing control panels 7a.

The landing control panels 7a and the elevator car control panel 7b may be coupled with the elevator controller 15 by means of electrical wiring not shown in FIG. 1, in particular by an electric bus, or by wireless data connections.

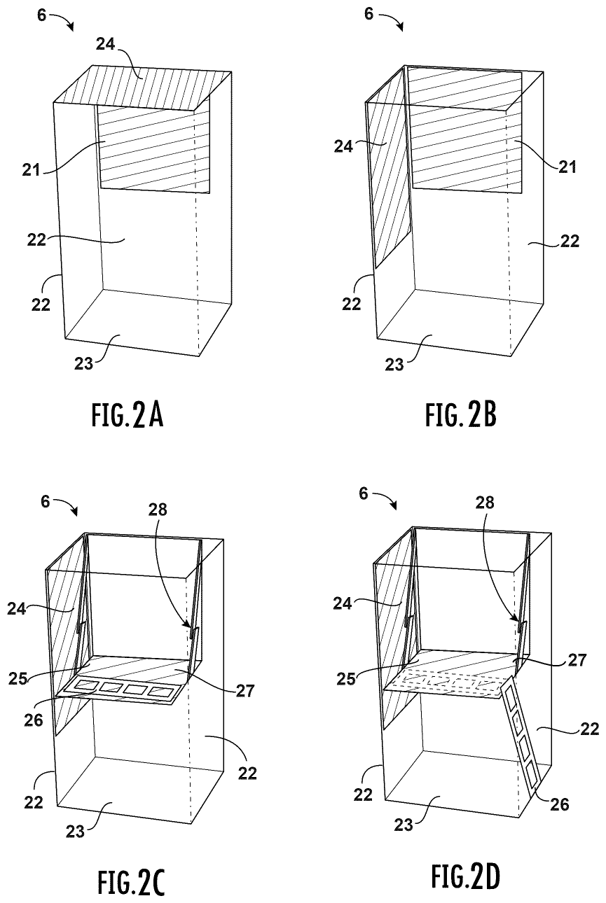

FIG. 2A shows the elevator car 6. The elevator car 6 comprises a working platform 21 that is pivotably/rotatably mounted on a sidewall 22 of the elevator car 6. The working platform 21 is arranged adjacent and in general parallel to the sidewall 22 of the elevator car 6 in a folded state. The elevator car 6 comprises a floor 23 and four sidewalls 22 extending vertically from the floor 23, preferably two sidewalls opposite from each other, a rear wall and a front side/front wall. In FIG. 2A to FIG. 2D, only two of the four sidewalls 22 are shown, while the other two sidewalls are omitted. The front side may comprise a door (not shown). On the opposite side of the floor 23, the elevator car 6 comprises a ceiling 24. The ceiling 24 is foldable towards one of the sidewalls 22. Thus, the ceiling 24 is openable to allow access to the upside of the elevator car 6.

FIG. 2B shows the elevator car 6 with the working platform 21 in the folded state and the ceiling 24 in an opened state. The ceiling 24 is pivoted towards the inside of the elevator car 6 and is positioned essentially adjacent and parallel to the sidewall 22. The working platform 21 does extend from the sidewall 22 into the interior of the elevator car 6, but only in an extension that does not infer with the pivoting ceiling 24.

Thus, a user or a mechanic may access the upside/upper area of the elevator car 6 or the hoistway 4 for maintenance or repairs.

FIG. 2C shows the elevator car 6 with the working platform 21 in an unfolded state. In the unfolded state, the working platform 21 projects or protrudes from the sidewall 22. The working platform 21 preferably projects or protrudes from the sidewall 22 in a right angle or 90° angle. The working platform 21 comprises a standing plate 25 and a ladder 26. The ladder 26 is preferably connected to an upper surface 27 of the standing plate 25. The ladder 26 is moveably connected to the standing plate 25 and is in a retracted state in FIG. 2C. That means, the ladder 26 is positioned essentially adjacent and parallel to the standing plate 25 and abuts the upper surface 27 of the standing plate 25.

The ladder 26 may pivot around a joint or hinge that connects the ladder 26 and the standing plate 25. Alternatively, the ladder 26 may be slideably connected to the standing plate 25. The ladder 26 can be moved/extracted parallel to the standing plate 25. When the ladder 26 protrudes the standing plate 25, the ladder 26 can be pivoted towards the floor 23 of the elevator car 6. Preferably, the ladder 26 is as long as the length of the standing plate 25.

FIG. 2D shows the elevator car 1 with the working platform 21 in an unfolded state and the ladder 26 in an extended state. In the extended state, the ladder 26 connects the standing plate 25 and the floor 23. The ladder 26 allows the user to climb the standing plate 25. The standing plate 25 allows the user to stand higher than the floor 23 and reach through the open ceiling 24 of the elevator car 6. Thus, the user may reach objects inside the hoistway 4 of the elevator system 2 or objects on top of the elevator car 6.

The protruding working platform 21 is held in the unfolded state by at least one support strut 28. Preferably, the working platform 21 is held by two support struts 28 that connect the upper surface 27 of the standing plate 25 to an inner surface of the sidewall 22.

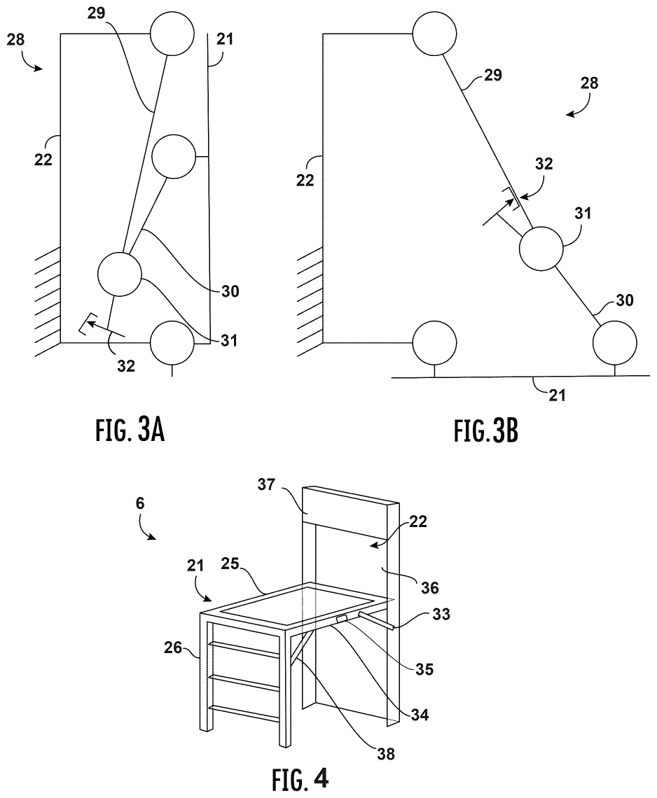

FIG. 3A shows the support strut 28 in the folded state of the working platform 21. A first/wall side 29 strut is pivotably connected to the sidewall 22 of the elevator car 6. A second/platform side 30 strut is pivotably connected to the working platform 21. The first strut 29 and the second strut 30 are pivotably/rotatably connected by a joint or hinge 31. In the folded state, the first strut 29 and the second strut 30 are arranged essentially adjacent and parallel to each other. Thus, the support strut 28 is folded or tucked in the space between the sidewall 22 and the working platform 21. The adjacent struts 29, 30 only require minimal space.

FIG. 3B shows the support strut 28 in the unfolded state of the working platform 21. The first strut 29 and the second strut 30 essentially form a straight line. That is, an angle between the first strut 29 and the second strut 30 is essentially 180°. The second/platform side strut 30 comprises a stopper/a mechanical stop 32 that engages with a corresponding lock at the first strut 29 and locks the two struts 29, 30 in the straight line/extended position. However, the mechanical stop 32 may be arranged at the first strut 29 and the lock may be arranged at the second strut 30.

FIG. 4 shows an elevator car 6 according to another embodiment. The working platform 21 protrudes or projects from the sidewall 22 in the unfolded state, preferably in the right angle. Thus, the working platform 21 and its standing plate 25 are arranged essentially horizontal and parallel to the floor 23 in the unfolded state. The standing plate 25 of the working platform 21 is supported by the at least one supporting strut that can be implemented as a pneumatic spring 33. Preferably, the standing plate 25 is supported by two hydraulic/pneumatic springs 33. The pneumatic springs 33 are connected to the sidewall 22 on the one side and to a lower surface 34 of the standing plate 25 on the opposite side. The ladder 26 is pivotably/rotatably connected to the lower surface 34 of the standing plate 25. When the standing plate 25 extends horizontal from the sidewall 22 in the unfolded state, the ladder 26 extends from its position under the standing plate 25 in its extended state. In the extended state, the ladder 26 may be arranged essentially vertical, preferably in a right angle to the standing plate 25. However, the ladder 26 may also comprise an angle different to 90 degrees regarding the standing plate 25. The ladder 26 connects the standing plate 25 and the floor 23. The ladder 26 may support the standing plate 25 in its unfolded state. The ladder 26 may pivot from its retracted into its extended state through force of gravity.

The working platform 21 may be locked against the sidewall 22 in the folded state by a locking mechanism. The locking mechanism may comprise two magnets 35 that are attached to the lower surface 34 of the standing plate 25. Preferably, the lower surface 34 of the standing plate 25 abuts the sidewall 22 in the folded state. The working platform 21 may be slidably and pivotably mounted in the sidewall 22. The sidewall 22 may comprise a recessed portion 36 and a panel/holding portion 37. The working platform 21 may be mounted in the recessed portion 36 and close with the holding portion 37 in the folded state. The holding portion 37 may be in the same optics as the panel on the other sidewalls. The upper surface of the working platform 21 may have the same look or appearance as the holding portion 37 or the panel of the other sidewalls. Thus, the working platform 21 is hidden in its folded state.

In the extended state of the ladder 26, a steel angle/ladder strut 38 may be positioned between the ladder 26 and the standing plate 25 holding the ladder 26 in its extended state.

What is claimed is:

1. Elevator car (6) with a working platform (21), characterized in the working platform (21) being pivotably mounted on a sidewall (22) of the elevator car (6), such that the working platform (21) is arranged adjacent and essentially parallel to the sidewall (22) of the elevator car (6) in a folded state, and protrudes from the sidewall (22) in an unfolded state, preferably in a 90° angle, the working platform (21) comprising a standing plate (25).

2. Elevator car (6) according to claim 1, wherein the working platform (21) comprises a ladder (26) that is moveably connected to the standing plate (25).

3. Elevator car (6) according to claim 2, wherein the ladder (26) is arranged adjacent and parallel to the standing plate (25) in a retracted state and extends towards a floor (22) of the elevator car (6) in an extended state.

4. Elevator car (6) according to claim 3, wherein the ladder (26) abuts against a lower surface (34) of the standing plate (25) in the retracted state and supports the standing plate (25) in the extended state.

5. Elevator car (6) according to claim 3, wherein the ladder (26) abuts against an upper surface (27) of the standing plate (25) and pivots around an edge of the standing plate (25), preferably around a longitudinal side and/or a side edge of the standing plate (25).

6. Elevator car (6) according to claim 1, wherein the working platform (21) comprises at least one supporting strut (28) that is mounted on the standing plate (25) on the one side and mounted on the sidewall (22) of the elevator car (6) on the opposite side.

7. Elevator car (6) according to claim 6, wherein the at least one supporting strut (28) comprises a first strut (29) and a second strut (30) that are pivotably connected to each other such that the first strut (29) and the second strut (30) are arranged essentially parallel to each other in the folded state and are arranged in a essentially straight line in the unfolded state.

8. Elevator car (6) according to claim 7, wherein one of the first strut (29) and the second strut (30) comprises a mechanical stop (32) that fixes the first strut (29) and the second strut (30) in the essentially straight line.

9. Elevator car (6) according to claim 6, wherein the at least one supporting strut (28) is a pneumatic spring (33) which is attached to the lower surface (34) of the standing plate (25).

10. Elevator car (6) according to claim 1, wherein the working platform (21) is locked in the folded state with a locking mechanism, preferably at least one magnet (35).

11. Elevator car (6) according to claim 1, wherein the elevator car (6) comprises a vacuum lifting pad to pivot the working platform (21) from the folded state in the unfolded state.

12. Elevator car (6) according to claim 1, wherein the standing plate (25) comprises a first layer made out of a panel material and a second layer, wherein the second layer comprises wood, honeycomb or a composite material.
